(19) United States
(12) Patent Application Publication
(10) Pub. No.: US 2005/0008059 A1
(43) Pub. Date: Jan. 13, 2005

(54) Laser apparatus

(76) Inventors: Hiroshi Nunokawa, Tokyo (JP); Tamotsu Miyazaki, Tokyo (JP); Satoru Amano, Tokyo (JP)

Correspondence Address: DELLETT AND WALTERS, P. O. BOX 2786, PORTLAND, OR, 97208-2786, US

(21) Appl. No.: 10/874,705

(22) Filed: Jun. 22, 2004

(30) Foreign Application Priority Data
Jun. 23, 2003 (JP) 2003-177815
Jun. 30, 2003 (JP) 2003-188936

(51) Int. Cl. H01S 3/08; H01S 3/13

(52) U.S. Cl. 372/98; 372/106; 372/29.021

(57) ABSTRACT

The laser apparatus is disclosed that includes laser medium, a pair of mirrors and a regulator contained in the case, and is capable to regulate the output laser power without affection to the character of the laser light. A half-wave plate receives the laser light excited in the laser medium and rotates the plane of polarization of the laser light. A polarizer receives the laser light passed through the half-wave plate and separates the laser light into the first polarized straight light and the second polarized branch light. A photo detector detects the intensity of the second polarized light. According to the detected intensity, the half-wave plate is controlled to rotate to keep the intensity of the first polarized straight light constant. The laser apparatus also includes a maximum output display device to display the maximum output of the laser light and a final output display device to display the final output of the laser light.

### BACKGROUND OF THE INVENTION

1. Field of the Invention

The present invention relates to the laser apparatus, and in particular, to the laser apparatus that can emit stably for a long time high power laser light suitable for laser processing machines and laser exposure devices and can display the output power of the laser light.

2. Prior Art

Small-sized solid-state laser apparatus that emits short wavelength laser light with combination of solid-state laser medium and nonlinear optical crystal is conventionally employed for fine-working machines or exposure devices. In addition to compactness and high power output, precise output control is demanded of this kind solid-state laser apparatus. And also very small fluctuation of laser output is necessary in order to process the work pieces stably. Output power of solid-state laser light source to pump solid-state laser medium is increasing. Accordingly, solid-state laser apparatus is also developing into high power and high efficiency. It is also demanded that output laser power should be regulated safely in usage of laser apparatus.

Hereinafter, some conventional laser apparatuses are explained. In the Japanese laid open patent document JP56-76587, a pulse laser device with small-sized resonator employing a Porro prism is disclosed. This pulse laser device is composed of solid-state laser medium 204 and a polarizer 206 on the first optical axis between the phase-shift mirror 200 and the Porro prism 202 as shown in FIG. 1. A Pockels cell 210 and a quarter-wave plate 212 are placed on the second optical axis between a reflecting mirror 208 and the Porro prism 202. The pumping means excites the solid-state laser medium 204 between the phase-shift mirror 200 and the reflecting mirror 208 in the resonator and laser light is induced in the laser medium. The light repeats traveling between the mirrors on the optical axis folded by the Porro prism 202. Thus the laser oscillation occurs.

In the Japanese laid open patent document JP09-199394, an illuminating apparatus for exposure is disclosed. By changing the polarization state of the light from a light source, the output exposure amount can be controlled accurately without mechanical shutter. As shown in FIG. 2, the light source 300 of the illuminating apparatus for exposure generates UV light of predetermined polarization. The half-wave plate as the polarization control means change the polarization state of the light from the light source 300. The polarizer 304 as the light intensity control means changes the intensity of the light according to the polarization under the control of the control means 306. The beam splitter 308 deflects a portion of the light from the light intensity control means. The photo detector 310 detects the intensity of the deflected light from the beam splitter 308. The polarization control means is controlled so that the light intensity detected by the photo detector 310 is kept constant.

In the Japanese laid open patent document JP11-97782, a solid laser device is disclosed. The light intensity can be stably controlled in case of high power laser output. As shown in FIG. 3, there is the first optical system with the solid-state laser medium 404 and the first quarter-wave plate 406 on the first optical axis between the polarizer 400 and the first reflecting mirror 402. The reflecting plane of the first reflecting mirror 402 is rectangular to the first optical axis. There is the second optical system composed of Pockels cell 410 and the second quarter-wave plate 412 on the second optical axis between the polarizer 400 and the second reflecting mirror 408. The reflecting plane of the second reflecting mirror 408 is rectangular to the second optical axis. The polarizer 400 transmits the first polarization component of the incident light of the first optical axis. The polarizer 400 reflects the second polarization component rectangular to the first plane of polarization to the direction of the second optical axis. The pumping light excites the solid-state laser medium and gives rise to population inversion. The rotation-drive means rotates the first quarter-wave plate 406 on the first optical axis. The beam splitter 413 branches a part of the laser light from the polarizer 400. The photo detector 414 detects the intensity of the branched light. The control circuit 416 controls the rotation drive means according to the detected light intensity. The first quarter-wave plate 406 can regulate the intensity of the laser light out of the solid laser device by adjusting the rotation angle.

In the pulse laser device disclosed in the Japanese laid open patent document JP56-76587, the intensity of the laser light can be adjusted by controlling the pumping means to some extent. But there is a problem that the stable control of the intensity of the laser light is difficult.

In the illuminating apparatus for exposure disclosed in the Japanese laid open paten document JP9-199394, it is regarded to regulate the output power of the laser beam or to keep it constant. But it is not regarded that decreased power of the laser light less than the expected normal value for the processing of work pieces. Decrease of power is caused by degradation of pumping light source of long-term use. Offset of optical axis by vibration or decay of the nonlinear optical crystal causes also decrease of output power. Such decrease of power should be compensated. That is, the output power of the solid-state laser excited by LD (laser diode) decreases with time. One reason is the lifetime of the pumping LD. Another reason is the misalignment of the optical axis of the resonator caused by the vibration.

It is known that the output laser power can be controlled stably for a while as the LD current is increased according to the decrease of the output laser power. Even by this method, the output power of LD can be kept constant for only short 5000 hours. Accordingly, the lifetime of LD excited laser is also as short as LD lifetime itself. Therefore, much longer stability than LD lifetime is required of the output laser power.

In the solid laser device disclosed in the Japanese laid open patent document JP11-097782, the first optical system and the second optical system with a quarter-wave plate are needed. Therefore, there is a problem that the total optical system becomes complex. And also, there-is another problem that the beam shape and character might be varied. When the laser power is regulated in the resonator, the power absorption is changed in the laser medium of the resonator. The thermal gradient varies in the laser medium and then the beam path alters in the resonator. It changes the beam shape and character of the laser light emitted by the resonator.

A user can install a power regulator outside the laser case. At that time, the optical axis of the laser light out of the case should be aligned to the power regulator. Moreover, dust control and safety arrangement are also required for the power regulator.

Industrial LD-pumped solid-state laser is usually used in such a manner that output laser power is kept at the determined value. But, if the output laser power is regulated by means of raising the LD current, the output laser power cannot keep the predetermined level when the LD power decreases considerably by aging of LD. When the laser apparatus falls in such state, the LD-pumped solid-state laser must be stopped to fix. Moreover, the working process delays much because it takes a long time before the repairperson arrives. So, it is required to alert that the output laser power comes to the critical level near the predetermined limit. And also the manufacturer of the laser apparatus must be informed before the breakdown of the laser apparatus for rapid repair. But, by the above-mentioned output control method, it is very difficult to forecast or measure the lifetime able to maintain the LD output power at constant level. So, it is impossible to alarm just before falling in the critical state near the predetermined limit. That is also true about the decay of nonlinear optical crystal same as about the decay of LD.

Consider that the total-reflecting mirror folds the optical axis of laser light of LD-pumped solid-state laser. For example, the total-reflecting mirror is arranged at the angle of 45 degrees to the optical axis. The reflectance of laser light turning in right angle is varied according to the angle of plane of polarization of laser light. In order to keep high output power, the angle of the plane of polarization must be adjusted when the direction of the optical axis is changed. FIG. 4A shows that the total-reflecting mirror is arranged at the angle of 45 degrees to the optical axis. The reflectance of the laser light deflected in right angle by the total-reflecting mirror varies according to the angle of plane of polarization of laser light as shown in FIG. 4B. Plane of polarization of S-wave is perpendicular both to incident optical axis and normal of reflective plane. Plane of polarization of P-wave is parallel with the plane formed by incident optical axis and normal of reflective plane.

It is known that a half-wave plate inserted in the optical axis of the laser light can adjust the angle of the plane of polarization. But there is a problem in this method that the required space and the cost for the apparatus increase as the optical components increase.

On the other hand, in the LD-pumped solid-state laser for laboratory use, the characters of nonlinear optical crystal or polarizer depending deeply on the angle of plane of polarization are sometimes measured by varying the angle of plane of polarization continuously with keeping constant output laser power. It is known that the half-wave plate inserted at the exit of the LD-pumped solid-state laser can rotate the plane of polarization by the rotation on the optical axis. As the LD current is adjusted when the output laser power is varied, the shape or character of the laser beam might be varied. Under the condition that the output laser power is variable, the output laser power cannot be kept constant stably for a long time as affected by the lifetime of LD. Thus, there is a problem that the angle of the plane of polarization cannot be varied continuously keeping the output laser power at the arbitrary constant level for a long time.

### SUMMARY OF THE INVENTION

An object of this invention is that, solving the above-mentioned problems, the final output laser power, even high power, can be stably kept for a long time safely and easily without change of shape and character of final laser beam and that the angle of the plane of polarization can be varied continuously with keeping the final output laser power constant for a long time.

Another object of this invention is to provide with the laser apparatus that is composed of reduced optical components, the alignment of optical components is easy and the laser output power is stabilized.

Another object of this invention is to provide with the laser apparatus of which timing to fix can be decided adequately and operation efficiency is quite high.

Another object of this invention is to provide with the laser apparatus of which laser light polarization angle can be varied continuously with keeping the laser output power constant for a long time.

A further object of this invention is to provide the laser apparatus of which operation status can be easily observed with eyes when the laser light polarization angle is varied continuously with long-time constant output power.

A further other object of this invention is to provide with the laser apparatus of which operation status can be monitored easily with stable laser output power.

A further other object of this invention is to provide with the laser apparatus of which optical component status can be checked upon the disaccord of power-to-angle graph with cos² (2θ) (θ: rotation angle of the half-wave plate) because of the damage of a half-wave plate or a polarizer.

A further other object of this invention is to provide with the laser apparatus of easy maintenance with a resonator output display for continuous monitoring of resonator output.

A further other object of this invention is to provide with the laser apparatus that includes an alarm display device to display the predetermined critical ratio of the resonator output to the final output in order to enable the real-time comparison of the resonator output with the final output and to enable the accurate decision of fix-timing for high operation efficiency.

In order to achieve the above-mentioned object, the laser apparatus of this invention comprises a half-wave plate to rotate the plane of polarization of the laser light receiving the laser light from the resonator, a polarizer to transmit the first polarized light and to deflect the second polarized light receiving the laser light from the half-wave plate, a photo detector to detect the intensity of the second polarized light deflected by the polarizer, a drive-control means to control the rotation of the half-wave plate according to the output of the photo detector to keep the intensity of the second polarized light at the predetermined value, a case to contain the laser medium, the pair of mirrors, the half-wave plate and the polarizer, and an exit window opened in the case to lead out the first polarized light.

And also in order to achieve the above-mentioned object, the laser apparatus of this invention comprises a half-wave plate to rotate the plane of polarization of the laser light receiving the laser light from the resonator, a polarizer to transmit the first polarized light and to deflect the second polarized light receiving the laser light from the half-wave plate, a photo detector to detect the-intensity of the output laser light passed through the half-wave plate and the polarizer, a drive-control means to control the rotation of the half-wave plate according to the output of the photo detector to keep the intensity of the output laser light at the predetermined value, a maximum output display device to display the maximum output power of the resonator, and a final output power display device to display the output laser light passed through the polarizer.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements.

### BRIEF DESCRIPTION OF THE DRAWINGS

The invention and advantages of the laser apparatus according to the present invention over the prior art laser apparatus will be more clearly appreciated from the following description taken in conjunction with the accompanying in which:

FIG. 1 shows the outline of the pulse laser device in prior art.

FIG. 2 shows the outline of the illuminating apparatus for exposure in prior art.

FIG. 3 shows the outline of the solid laser device in prior art.

FIGS. 4A and 4B show the beam splitter of the laser apparatus and the graph indicating the reflectivity of S-wave and P-wave.

FIG. 5 shows the overall construction of the solid-state laser apparatus of the first embodiment of this invention.

FIG. 6 shows the outline of the regulator employed in the laser apparatus of the first embodiment of this invention.

FIGS. 7A and 7B show the graph indicating the laser output relative value of the horizontally polarized laser light and the graph indicating the laser output character at the rotation angle θ of the half-wave plate of the solid-state laser apparatus of the first embodiment of this invention.

FIG. 8 shows the graph indicating the time-relationship of the laser output relative value and the rotation angle of the half-wave plate in the solid-state laser apparatus of the first embodiment of this invention.

FIG. 9 shows the outline of the output regulator employed in the solid-state laser apparatus of the second embodiment of this invention.

FIG. 10 shows the outline of the output regulator employed in the solid-state laser apparatus of the third embodiment of this invention.

FIG. 11 shows the outline of the display device of the operational consol in the solid-state laser apparatus of the third embodiment of this invention.

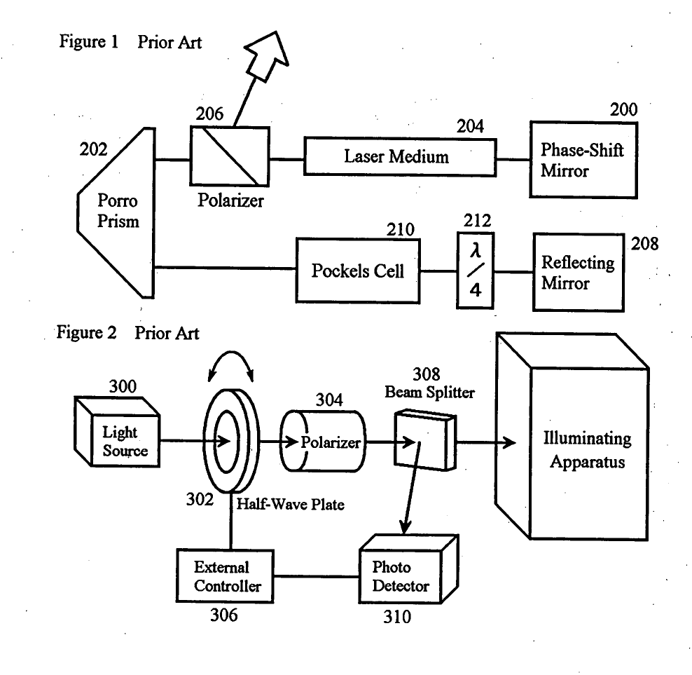

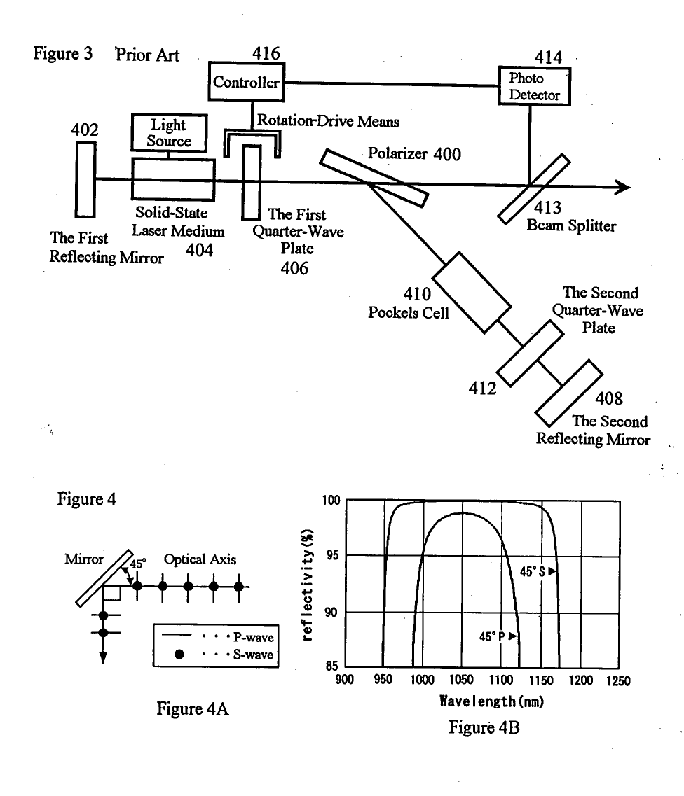

### DETAILED DESCRIPTION

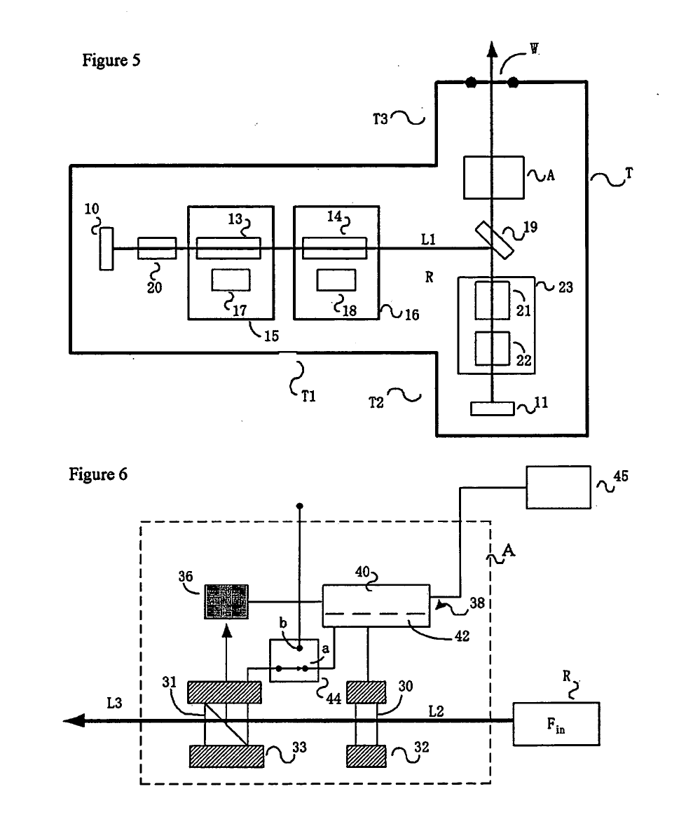

Hereinafter, the preferred embodiments of this invention are explained in detail referring to FIGS. 5-11.

(The First Embodiment)

The first embodiment of this invention is the solid-state laser apparatus wherein the resonator output is divided into straight beam and the branch beam by the polarizer and the intensity of the straight beam is kept constant by the rotation of the half-wave plate disposed just after the resonator according to the detected intensity of the branch light.

FIG. 5 shows the construction of the solid-state laser apparatus of the first embodiment of this invention. In FIG. 5, mirrors 10 and 11 are a pair of reflecting mirrors. The laser rods 13 and 14 are the laser media to generate the elementary wave of 1064 nm in wavelength. The elementary wave may be even in other wavelength. The pumping modules 15 and 16 are the units that excite the laser media to generate light. The laser diodes 17 and 18 are devices to excite the laser media with the laser light. The beam splitter 19 is the optical element that transmits the harmonic laser light and deflects the elementary laser light. Q-switch 20 is to control the laser oscillation. The nonlinear optical crystals 21 and 22 are the optical elements to generate the harmonics from the elementary laser light. The harmonic generation module 23 is the unit to generate the harmonic laser light.

The regulator A is the means to regulate the intensity of the laser light. The optical axis L1 is the optical axis of the elementary laser light. The resonator R is to oscillate the laser light. The case T is to contain the components to generate the laser light. The first arm T1 is the part of the case to contain the pumping elements. The second arm T2 is the part of the case to contain the elements to generate the harmonics. The third arm T3 is the part of the case to contain the regulator A. The exit window W is to lead the final laser light out of the case.

The pumping modules 15 and 16 composed of the laser rods 13 and 14 generate the elementary wave of 1064 nm in wavelength. They are placed in series on the optical axis L1 between the pair of mirrors 10 and 11 of the resonator R. The laser rods 13 and 14 are made of Nd:YVO₄ for example. These pumping modules 15 and 16 have the laser diodes 17 and 18 on the side of each laser rods in order to excite the laser rods 13 and 14. Though pumping modules are two in this example, the pumping modules may be even three. Q-switch 20 is disposed between the mirror 10 and the pumping module 15.

Between the pumping module 16 and the reflecting mirror 11, there are disposed the beam splitter 19 and the harmonics generating module 23 composed of nonlinear optical crystals 21 and 22 to generate the third harmonic wave. In this example, LBO type II is employed to generate the third harmonic wave. In case to generate the second harmonic wave, LBO type I is used. The other nonlinear optical crystals such as KTP, KDP, LNO, BBO or CLBO may be used. T-shaped case T contains the optical elements such as the mirrors 10 and 11, the pumping modules 15 and 16, the beam splitter 19, the harmonic generating module 23 and so on. This case T also contains the regulator A that regulates the power of the harmonic laser beam separated by the beam splitter 19.

The pumping modules 15 and 16 and the Q-switch 20 are contained in the first arm T1 at the left of the T-shaped case T. The beam splitter 19 is on the boundary between arms. The harmonic generating module 23 is contained in the second arm T2 of the T-shaped case T. The regulator A is contained in the third arm T3 of the T-shaped case T. Inert gas such as nitrogen gas is filled in the case T for stable laser oscillation. As shown in FIG. 5, the regulator A is placed between the beam splitter 19 and the exit window w opened at the end of the third arm T3.

FIG. 6 shows the outline of the regulator A employed in the solid-state laser apparatus of the first embodiment of this invention. In FIG. 6, the half-wave plate 30 is the means to rotate the plane of polarization of the resonator output laser light. The polarizer 31 is the means to separate the horizontally polarized light and the vertically polarized light. The motor 32 is the means to rotate the half-wave plate 30. The motor 33 is the means to rotate the polarizer 31. The photo detector 36 is the means to detect the power of the laser light branched by the polarizer 31. The drive-control means 38 is the device to control the motors 32 and 33. The logic circuit 40 is to operate logically the output signal of the photo detector 36 and to yield the signal in accordance with the output signal of the polarizer 31.

The drive circuit 42 is to drive the motors 32 and 33 according to the operation result of the logic circuit 40. The drive-control means 38 includes the logic circuit 40 and the drive circuit 42 and is connected to the photo detector 36. The switch 44 is the changing means to drive the motor 33 from outside of the laser apparatus. The switch 44 between the drive circuit 42 and the motor 33 of the polarizer 31 is installed in order to enable to drive the motor 33 solely from outside of the case T when required. The alarm means 45 is to give warning according to the operation result of the logic circuit 40. The regulator A includes the half-wave plate 30, polarizer 31, motor 32, motor 33, photo detector 36 and drive-control means 38. The half-wave plate 30 and the polarizer 31 are disposed on the optical axis L2 of the laser light.

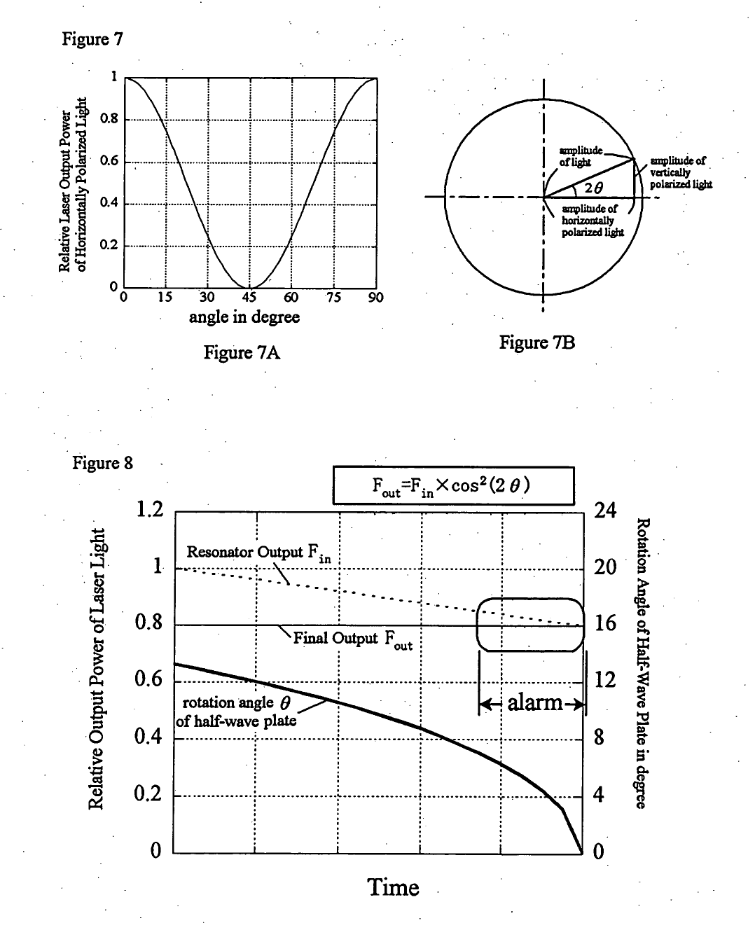

FIG. 7A shows the graph that indicates the relative output laser power of the horizontally polarized laser light and FIG. 7B shows the graph that indicates the output laser amplitude with the rotated half-wave plate in the first embodiment of this invention. FIG. 8 shows the graph that indicates the relationship between the relative output laser power and the rotation angle θ of the half-wave plate of the solid-state laser apparatus.

The operation of the solid-state laser apparatus of the first embodiment of this invention as constructed above is explained. First, referring to FIGS. 5 and 6, the outline of the function of the solid-state laser apparatus is explained. The resonator R resonates at the elementary frequency. The laser light reflects repeatedly between the first mirror 10 and the second mirror 11. The elementary laser light is converted to the third harmonic wave by the harmonic generating module 23. The beam splitter 19 functions to derive only this converted third harmonic wave out of the case T through the regulator A.

As shown in FIG. 6, in the regulator A, the laser light in optical axis L2 is incident to the polarizer 31 through the half-wave plate 30. The polarizer 31 is corresponding to the light of 355 nm in wavelength of the third harmonic wave. On the optical axis of the laser light out of the half-wave plate, the polarizer 31 is held at the angle so as the transmission intensity of the horizontally polarized light is maximal. This polarizer 31 in cooperation with the half-wave plate 30 performs the function of the control means of the light intensity. The intensity of the laser light out of the polarizer 31 varies according to the angle of the plane of polarization of the laser light of optical axis L2 out of the half-wave plate 30. The laser beam with regulated intensity by the polarizer 31 comes out of the exit window of the case T. And it is applied on various objects to be processed.

Next, referring to FIG. 7, the method to regulate the intensity of the output laser light is explained. The example that the resonator output laser light is horizontally polarized is explained. It is just the same when the light is vertically polarized. The resonator output laser light may be enough linearly polarized at the specific angle. In this example, the resonator output laser light is assumed horizontally polarized. The rotation angle of the polarizer 31 is adjusted to transmit the horizontally polarized light (the first polarized light) and to branch the vertically polarized light (the second polarized light). The plane of polarization of the laser light incident to the polarizer 31 rotates according to the rotation of the half-wave plate 30. When the half-wave plate 30 is rotated, the plane of polarization of the resonator output laser light is rotated. When the resonator output power is maximal, the angle θ of the half-wave plate 30 at that state is defined as 0 degree. When the polarized light is incident to the polarizer 31 from the half-wave plate 30, the horizontally polarized component of the laser light passes through the polarizer 31. The vertically polarized component is deflected to the direction of photo detector 36 by the polarizer 31.

In this laser apparatus, let the rotation angle of the half-wave plate 30 be θ and the intensity of the resonator output laser light be Fᵢₙ. The final output intensity Fₒᵤₜ is written as
Fₒᵤₜ=Fᵢₙ cos²(2θ).
That is, in this laser apparatus, as shown in FIGS. 7A and 7B, the intensity Fₒᵤₜ of the final output laser light varies depending upon the rotation angle θ of the half-wave plate 30. When the half-wave plate is rotated by the angle θ as the signal is given to the motor 32 from the drive-control means 38, the laser light of optical axis L2 through the half-wave plate 30 becomes the linearly polarized light with 2θ of the angle of the plane of polarization. The final output intensity Fₒᵤₜ varies continuously in accordance with the rotation angle θ of the half-wave plate 30. Thus, the final output intensity Fₒᵤₜ can be varied continuously. The examples of this polarizer are Glan-Laser polarizing prism, Glan-Taylor polarizing prism, Glan-Thompson polarizing prism and polarization beam splitter.

Next, referring to FIG. 8, the method to keep the intensity of the final output laser light at the predetermined value is explained. Let the intensity of the resonator output laser light be Fᵢₙ. Let the initial maximum intensity of the resonator output laser light be Fₘₐₓ. Let the intensity of the final laser be Fₒᵤₜ. Let the relative value normalized by Fₘₐₓ be the relative power. The logic in the logic circuit 40 is set up so that the final output Fₒᵤₜ is always kept at the predetermined rate (e.g. 80%) with respect to the initial maximum intensity Fₘₐₓ. The predetermined relative power rate may be in the range of 0.3-0.95. The relative power rate near 1.0 is not practical because the laser apparatus falls uncontrollable soon.

As shown in FIG. 8, at the beginning of the use of the laser apparatus, the resonator R is working at maximum output power and the laser output relative value is 1. After a while, according to the aging of the laser medium and pumping light source, the laser output relative value of the resonator output laser light decreases. For example, when the laser output relative value of Fₒᵤₜ is set up at 0.8, at the beginning of the use of the laser apparatus, the rotation angle θ of the half-wave plate 30 is 13.5 degrees. When the relative value of the resonator output becomes 0.9, the rotation angle θ of the half-wave plate 30 becomes about 10 degrees.

Concretely, the photo detector 36 detects the intensity of the vertically polarized component of the laser light branched by the polarizer 31. The half-wave plate 30 is rotated by the motor 32 driven by the output signal from the drive circuit 42 in the drive-control means 38 according to the output signal of the photo detector 36. According to the rotation angle, the plane of polarization of the resonator output laser light rotates. Even if the intensity of the resonator output laser light decreases with time, the intensity of the laser light of optical axis L3 can be kept constant by way that the rotation angle θ of the half-wave plate 30 is decreased according to the decrease of the resonator output laser light. For example, according to the rotation angle θ of the half-wave plate 30 and the intensity Fᵥ of the vertically polarized light detected by the photo detector 36, the intensity of the resonator output Fᵢₙ can be obtained from the equation
Fᵢₙ=Fᵥ(1/sin²(2θ)).
The rotation angle θ′ of the half-wave plate 30 where Fₒᵤₜ is 0.8 times Fₘₐₓ can be obtained using Fᵢₙ by solving the equation
Fₒᵤₜ=Fᵢₙ cos²(2θ′)=0.8 Fₘₐₓ

The intensity of the final output laser light can be kept constant if the rotation angle of the half-wave plate 30 is set up to θ′. Because that the photo detector 36 detects the intensity of the laser light branched by the polarizer 31 furnished originally in the laser apparatus, no other beam splitter is needed on the optical axis L2 of the laser light. Therefore, the alignment of the optical elements becomes easy and the decrease of the final output power is avoided, and also the cost of the laser apparatus is decreased.

When the relative value of the resonator output Fᵢₙ becomes 0.85 for example, the user of the laser apparatus is informed of need of repair of the laser apparatus alarming by the alarm means 45 signaled from the logic circuit 40. In the state that the solid-state laser apparatus is stably controlling the laser output power, the laser output relative value can be seen from the rotation angle θ of the half-wave plate 30 on the optical axis. Suppose that the resonator output laser power decreased to the present power Fᵢₙ by aging from the initial maximum power Fₘₐₓ. The resonator output Fᵢₙ is calculated with the equation
Fᵢₙ=Fₒᵤₜ(1/cos²(2θ))

The alarm can be given when the final laser output becomes unable to be controlled stably as the present resonator output Fᵢₙ becomes near the predetermined value. For example, the alarm is given when the laser output becomes unable to be controlled stably as the relative value of the resonator output becomes near 0.8. It is very helpful for the early repair of the laser apparatus.

Next, the method to rotate the plane of polarization of the laser light is explained. The plane of polarization of the laser light out of the half-wave plate 30 rotates by the angle of 2θ when the half-wave plate 30 is rotated by the angle θ on the optical axis. The polarization plane of the final output laser light rotates by the angle θ when the polarizer 31 is rotated by the angle θ on the optical axis. The motor 33 to rotate the polarizer 31 and the motor 32 to rotate the half-wave plate 30 are simultaneously rotated under the condition that the ratio of the angular velocity of rotation is 2:1. The plane of polarization of the laser light between the half-wave plate 30 and the polarizer 31 rotates by the angle of 2θ when the half-wave plate is rotated by the angle θ according to the rotation of the motor 32. The plane of polarization of the final output laser light rotates by the angle of 2θ when the polarizer 31 is rotated by the angle of 2θ according to the rotation of the motor 33.

According to this method, the final output laser power is not varied during the rotation of the plane of polarization. Therefore, the final output laser power can be kept constant for a long time if the plane of polarization is rotated by the simultaneous rotation of the polarizer 31 and the half-wave plate 30 with 2:1 ratio of the rotation angular velocity. In this way, the angle of the plane of polarization can be varied continuously with constant final output laser power. In this case, the switch 44 is connected to the point a. When the alignment of the half-wave plate 30 and the polarizer 31 is adjusted, the switch 44 is connected to the point b, then the motor 33 to rotate the polarizer 31 can be driven independently outside of the laser apparatus.

As explained above, in the first embodiment of this invention, the solid-state laser apparatus is constructed as follows. The resonator output laser light is divided into straight beam and the branch beam by the polarizer. The intensity of the straight beam is kept constant by the rotation of the half-wave plate placed just after the resonator according to the detected intensity of the branch light. Therefore, the optical components can be reduced, the alignment of optical components becomes easy and the final output laser power can be stabilized.

(The Second Embodiment)

The second embodiment of this invention is the solid-state laser apparatus wherein the beam splitter deflects a part of the final output laser light to the photo detector, the half-wave plate is driven according to the detected intensity and the final output laser power is controlled to keep constant.

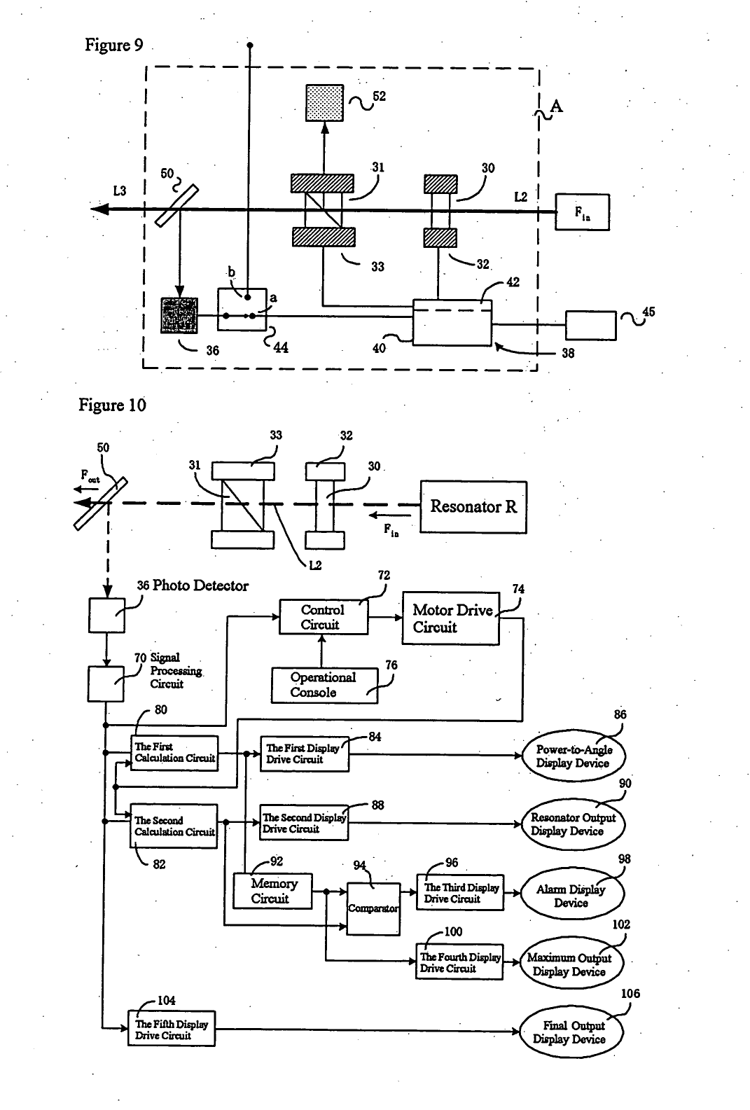

FIG. 9 shows the outline of the regulator A employed in the solid-state laser apparatus of the second embodiment of this invention. In FIG. 9, the beam splitter 50 is the optical element to deflect a part of laser light. The damper 52 is the means to absorb the light branched by the polarizer 31. The regulator A is composed of the half-wave plate 30, polarizer 31, motor 32, motor 33, photo detector 36, drive-control means 38, logic circuit 40, motor drive circuit 42 and switch 44. The alarm means 45 is connected to the logic circuit 40. The half-wave plate 30 and the polarizer 31 are disposed on the optical axis L2 of the resonator output laser light. The motor 32 drives the half-wave plate 30 to rotate. The motor 33 drives the polarizer 31 to rotate. The drive-control means 38 is connected to the photo detector 36.

The logic circuit 40 is one part of the drive-control means. Not shown in the figure, same as the first embodiment, the switch 44 is installed between the drive circuit 42 and the motor 33 to control to drive the motor 33 from outside of the case T when required. The drive-control means 38 includes the logic circuit 40 to receive the output signal of photo detector 36 and the drive circuit 42 for the motors 32 and 33. The same components coincident to those of the first embodiment are shown with the same reference numbers. The difference from the first embodiment shown in FIG. 6 is that the beam splitter 50 is disposed on the optical axis L3 of the laser light out of the polarizer 31 and the branched light from this beam splitter 50 is incident to the photo detector 36.

The operation of the solid-state laser apparatus of the second embodiment of this invention as constructed above is explained. The method to adjust the output laser power by rotating the half-wave plate 30 is the same as the first embodiment. The method to keep the intensity of the final output laser light at the predetermined value is explained. The beam splitter 50 on the optical axis L3 deflects a part of the incident laser light (e.g. 1%) from the polarizer 31. The photo detector 36 detects the intensity of the deflected laser light. The logic of the logic circuit 40 is set up so that the intensity Fₒᵤₜ of the final laser light of optical axis L3 is kept always at the constant rate (e.g. 80%) to the maximum output Fₘₐₓ of the laser light of optical axis L2. The motor 32 driven with the output signal of the drive circuit 42 in the drive-control means 38 rotates the half-wave plate 30 so that the signal level detected by the photo detector 36 becomes constant. The plane of polarization of the resonator output laser light rotates according to the rotation angle θ of the half-wave plate 30. Even if the resonator output decreased with time, the final output can be kept constant by way that the rotation angle θ of the half-wave plate 30 is decreased according to the decrease of the resonator output. As this control method is simple feedback control, the logic of the logic circuit 40 becomes simpler than that in the first embodiment.

Under the condition that the output laser power is controlled stably, the resonator output can be obtained from the rotation angle θ of the half-wave plate 30 on the optical axis. The aging of the laser source decreases the resonator output lower than the initial maximum output power. The resonator output Fᵢₙ is calculated with the equation
Fᵢₙ=Fₒᵤₜ(1/cos²(2θ)),
where Fₒᵤₜ is 0.8 times Fₘₐₓ.

The alarm is given when the resonator output Fᵢₙ reaches near the final output Fₒᵤₜ and stable control becomes difficult due to little allowance. For example, in case that the setup relative power of Fₒᵤₜ is 0.8, the alarm is given when the relative power of resonator output Fᵢₙ becomes 0.85. This is helpful for the early repair of the laser apparatus.

The method to rotate the plane of polarization of the final laser light is explained. When the half-wave plate 30 is rotated by the angle θ on the optical axis, the plane of polarization of the final output laser light rotates by the angle of 2θ. The motor 32 and the motor 33 rotate the polarizer 31 and the half-wave plate 30 simultaneously with the ratio of 2:1 of angular velocity of rotation. The angle of the plane of polarization can be varied continuously for a long time with keeping the output laser power constant. This method is the same as in the first embodiment, so no more detailed explanation is given.

As explained above, in the second embodiment of this invention, the solid-state laser apparatus is constructed as follows. The laser light out of the polarizer is divided into straight beam and the branch beam by the beam splitter. The branch beam is introduced to the photo detector. The intensity of the branch beam is detected. The half-wave plate is driven according to the detected value and the final output laser power is controlled to keep constant. Therefore, the optical components can be reduced, the alignment of optical components becomes easy and the output laser power can be stabilized.

(The Third Embodiment)

The third embodiment of this invention is the solid-state laser apparatus wherein a polarizer separates the resonator output laser light through the half-wave plate into straight beam and branch beam, the beam splitter deflects a part of the straight beam into a photo detector, the half-wave plate is rotated according to the detected signal so that the final output laser light is kept at constant intensity, and the status of the laser apparatus is displayed.

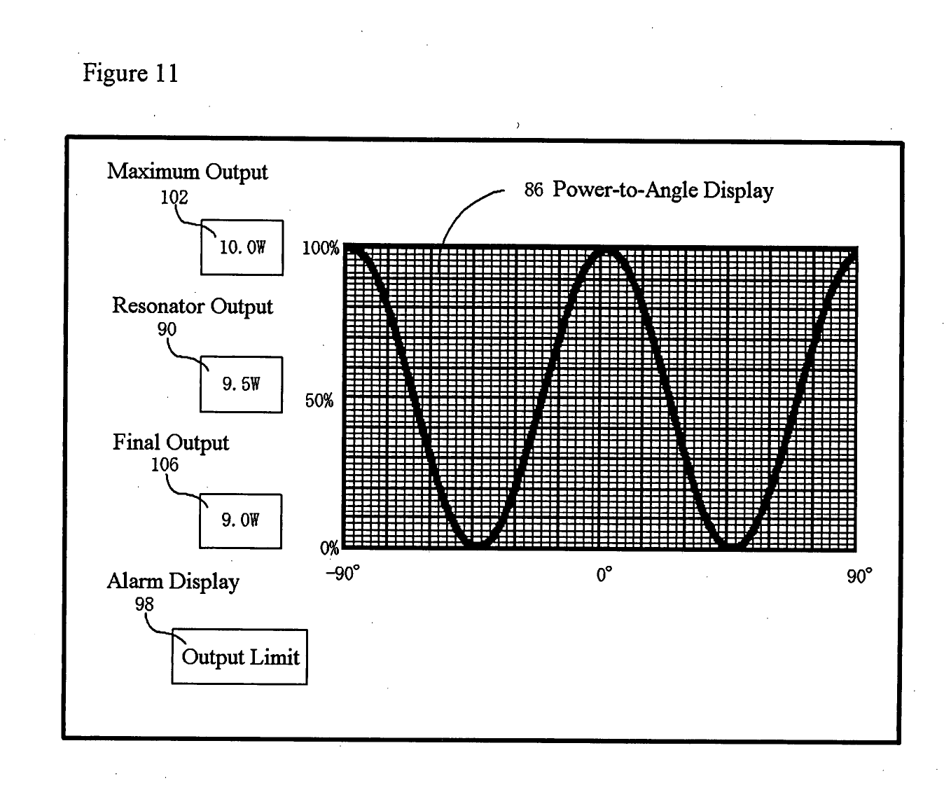

FIG. 10 shows the outline of the regulator employed in the solid-state laser apparatus of the third embodiment of this invention. The same reference numbers indicate the same components common in the first, second and third embodiments. FIG. 11 shows the outline of the display device of the operational console. In FIG. 10, the half-wave plate 30 is the means to rotate the polarization plane of the resonator output laser light. The polarizer 31 is the means to separate the incident light into the horizontally polarized light and the vertically polarized light. The motor 32 is the means to rotate the half-wave plate 30. It is driven according to the pulse number from the motor driver circuit explained later. The motor 33 is the means to rotate the polarizer 31. The beam splitter 50 is the optical element to deflect a part of the final output laser light. The photo detector 36 is the means to detect the power of the laser light deflected by the beam splitter 50. The regulator A includes the half-wave plate 30, polarizer 31, motor 32, motor 33, photo detector 36 and drive-control means. The half-wave plate 30 and the polarizer 31 are disposed on the optical axis L2 of the resonator output laser light.

The signal processing circuit 70 is the circuit to compensate the optical loss in the beam splitter 50, and to amplify the output signal of the photo detector 36, and to convert the analog signal to digital signal. The control circuit 72 has a microcomputer. It is connected to the motor drive circuit 74. It is also connected to the operational console 76 with RS232C. The motor drive circuit 74 is to drive the motor 32 with its output pulse. For example, the motor 32 is driven so as to rotate by one turn with 9000 pulses. The rotation angle θ of the half-wave plate 30 corresponding to the pulse number is provided to the operation circuit, not shown in the figure.

The first calculation circuit 80 is to calculate the relationship between the pulse number and the laser power. The pulse number is corresponding to the rotation angle of the motor 32. The first calculation circuit 80 receives the output pulse from the motor drive circuit 74 and the output signal from the signal processing circuit 70. The second calculation circuit 82 is to calculate the resonator output based upon the final output and the rotation angle θ of the half-wave plate 30. The second calculation circuit 82 receives the output pulse number from the motor drive circuit 74 and the output signal from the signal processing circuit 70. The output pulse number from the motor drive circuit 74 is corresponding to the rotation angle of the motor 32.

The second calculation circuit 82 divides the value of the output laser power with the function value according to the rotation angle of the motor 32 to obtain the resonator output. The first display drive circuit 84 is the means that receives the output signal from the first calculation circuit 80 and drives the display device 86 to display the power-to-angle graph. The second display drive circuit 88 is the means that receives the output signal from the second calculation circuit 82 and drives the resonator output display device 90 to display the resonator output.

The memory circuit 92 is the memory device that receives the output signal from the first calculation circuit 80 and stores the maximum value of the resonator output. The comparator 94 is the means to compare the output of the memory circuit 92 with the output of the second calculation circuit 82. The third display drive circuit 96 is the means that receives the output signal from the comparator 94 and drives the alarm display device 98 to display the decrease of the resonator output to the predetermined limit to alert the user of the laser apparatus.

The fourth display drive circuit 100 is the means that receives the output signal from the memory circuit 92 and drives the maximum output display device 102 to display the maximum resonator output. The fifth display drive circuit 104 is the means that receives the output signal from the signal processing circuit 70 and drives the final output display device 106 to display the present output value of the beam splitter 50. The display devices 86, 90, 102 and 106 are disposed in the operational console 76. The operational console 76 also includes the command means to start the motor drive circuit 74 and the setup means to set up the laser output of the beam splitter 50.

The operation to regulate the output of the solid-state laser apparatus of this embodiment is same as the first and the second embodiment shown with FIGS. 5, 6, 7A, 7B and 8. Only brief explanation of the regulator is given without details. Let the rotation angle of the half-wave plate be θ. Let the intensity of the laser light of the resonator R be resonator output Fᵢₙ. Let the intensity of the output laser light passed through the polarizer 31 be final output Fₒᵤₜ. The final output is written as
Fₒᵤₜ=Fᵢₙ cos²(2θ).
That is, in this solid-state laser apparatus, as shown in FIGS. 7A and 7B, the final output Fₒᵤₜ varies according to the rotation angle θ of the half-wave plate 30.

According to the command from the operational console 76, drive signal is given to the motor 32 from the control circuit 72 and the motor drive circuit 74. When the half-wave plate 30 is rotated with the angle θ, the laser light through the half-wave plate 30 becomes the linearly polarized light with the angle of 2θ of the plane of polarization. The intensity of the output laser light through the polarizer 31, i.e. the final output Fₒᵤₜ, varies continuously according to the rotation angle θ of the half-wave plate 30. Thus, the intensity of the output laser light (the final output) can be varied continuously.

Let the maximum intensity of the output laser light of resonator R be the maximum output Fₘₐₓ. Let the intensity of the output laser light of the resonator R be the resonator output Fᵢₙ. Let the intensity of the output laser light be the final output Fₒᵤₜ. Let the relative power compared to the maximum output Fₘₐₓ be the laser output relative power. The logic in the control circuit 72 is set up by the command from the operational console 76 so that the final output Fₒᵤₜ is always kept at the predetermined rate (e.g. 80%) with respect to the initial maximum intensity Fₘₐₓ. The predetermined relative power rate may be in the range of 0.3-0.95. The relative power rate near 1.0 is not practical because the laser apparatus falls uncontrollable soon.

As shown in FIG. 8, at the beginning of the use of the laser apparatus, the resonator R is operated at the maximum output power and its relative value is 1. After a while, according to the aging of the laser medium and pumping light source, the relative value of the resonator output decreases. For example, the relative value of the final output Fₒᵤₜ is set up at 0.8. At the beginning of the use of the laser apparatus, the rotation angle θ of the half-wave plate 30 is 13.5 degrees. When the relative value of the resonator output becomes 0.9, the rotation angle θ of the half-wave plate 30 becomes about 10 degrees. At the beginning of the use of the laser apparatus, the control circuit 72 and the motor drive circuit 74 rotate the half-wave plate 30 according to the command from the operational console 76 and the power graph is displayed on the power-to-angle display device 86. The peak value of the graph at that time is the maximum output Fₘₐₓ. The angle at the peak is defined as the base rotation angle of zero degree of the half-wave plate 30.

After the setup of the maximum output, the photo detector 36 detects the branch laser light from the beam splitter 50. In accordance with the output signal of the photo detector 36, the output pulses of the control circuit 72 drive the motor and the motor rotates the half-wave plate 30. According to the rotation angle of the half-wave plate 30, the plane of polarization of the laser light from the resonator R is rotated. Even if the resonator output decreases with time, the final output can be kept constant by decreasing the rotation angle θ of the half-wave plate 30 according to the decrease of the resonator output.

For example, from the rotation angle θ of the half-wave plate 30 and the final output Fₒᵤₜ detected by the photo detector 36, the resonator output Fᵢₙ is obtained by the equation
Fᵢₙ=Fₒᵤₜ(1/cos²(2θ)).

The rotation angle θ′ of the half-wave plate 30 when the final output Fₒᵤₜ is 0.8 times the maximum output Fₘₐₓ can be obtained with the resonator output Fᵢₙ by solving the equation
Fₒᵤₜ=Fᵢₙ cos²(2θ′)=0.8Fₘₐₓ

The final output can be kept constant with the rotation angle θ′ of the half-wave plate 30. That is, the angle of the half-wave plate may be controlled by feedback of intensity in order that the input to the control circuit is coincident with the predetermined value.

Referring to FIGS. 10 and 11, the display devices are explained. The first calculation circuit 80 calculates signals to display graphically the final output Fₒᵤₜ with respect to the rotation angle θ of the half-wave plate 30. The first calculation circuit 80 receives the output signal from the photo detector 36 via the signal processing circuit 70 and the pulses from the motor drive circuit 74. The signal with respect to the final output power is given to the first display drive circuit 84. The graph is displayed on the power-to-angle display device 86 with x-axis indication the rotation angle of the half-wave plate 30 as shown in FIG. 11.

The maximum final output at 0 degree of the rotation angle θ of the half-wave plate 30 is stored in the memory circuit 92. The maximum final output at the beginning is the same as the initial maximum resonator output Fₘₐₓ. The rotation position of the half-wave plate 30 at the initial maximum output is stored as 0 degree in the memory circuit. The initial maximum output is also stored in the memory circuit 92. As shown in FIG. 10, that value is given through the fourth display drive circuit 100 and is displayed on the maximum output display device 102.

The second calculation circuit 82 calculates signals to display the resonator output Fᵢₙ. The signal about the final output Fₒᵤₜ obtained by the photo detector 36 is given to the second calculation circuit 82 through the signal processing circuit 70. The second calculation circuit 82 receives the pulses showing the angle of the motor 32 from the motor drive circuit 74. The resonator output Fᵢₙ is calculated according to the equation
Fᵢₙ=Fₒᵤₜ(1/cos²(2θ)).

The calculation result is given through the second display drive circuit 88. It is displayed on the resonator output display device 90 as shown in FIG. 11. The fifth display drive circuit 104 receives the signal of the final output detected by the photo detector 36 from the signal processing circuit 70. The final output Fₒᵤₜ is displayed on the final output display device 106 as shown in FIG. 11.

The output of the memory circuit 92 and the second calculation circuit 82 are provided for to the comparator 94. When the relative value of the resonator output Fᵢₙ becomes 0.85 for example, the signal from the comparator is given through the third display drive circuit 96. The alarm is displayed on the alarm display device 98. The user is informed of the necessity of the repair of the laser apparatus. While the final output is controlled stably, the relative value of the resonator output can be observed relied upon the rotation angle θ of the half-wave plate 30 on the optical axis. Assume that the resonator output decreased from the initial maximum output Fₘₐₓ to the present resonator output Fᵢₙ because of aging. The second calculation circuit 82 calculates the resonator output Fᵢₙ with the equation
Fᵢₙ=Fₒᵤₜ(1/cos²(2θ))

When it becomes difficult to control the final output stably because the resonator output Fᵢₙ reaches near the final output Fₒᵤₜ, the alarm can be given. For example, when it becomes difficult to control the final output stably because the relative value of the resonator output reaches near 0.8, alarm is given. It is helpful for the early repair of the laser apparatus.

As explained above, in the third embodiment of this invention, the solid-state laser apparatus is constructed as follows. A polarizer separates the resonator output laser light through the half-wave plate into straight beam and branch beam. The beam splitter deflects a part of the straight beam into a photo detector. The half-wave plate is rotated according to the detected signal so that the final output laser light is kept at constant intensity. The status of the laser apparatus is displayed. As constructed above, the optical components can be reduced, the output laser power can be stabilized and the operation state of the laser apparatus can be seen easily.

While a plural embodiments of the present invention have been shown and described, it will be apparent to those skilled in the art that many changes and modifications may be made without departing from the invention in its broader aspects. The appended claims are therefore intended to cover all such changes and modifications as fall within the true spirit and scope of the invention.

1. A laser apparatus comprising:
a resonator to amplify laser light excited in a laser medium disposed between a pair of mirrors while the laser light reflects at said mirrors,
a half-wave plate to rotate the plane of polarization of the resonator output laser light,
a polarizer to transmit a first polarized light and to deflect a second polarized light receiving the laser light from said half-wave plate,
a photo detector to detect the intensity of the laser light out of said polarizer,
a drive-control means to control the rotation of said half-wave plate according to the output of said photo detector to keep the intensity of the laser light out of said polarizer at the predetermined value,
a case to contain said laser medium, said pair of mirrors, said half-wave plate and said polarizer, and
an exit window opened in said case to lead out the first polarized light.

2. A laser apparatus comprising:
a resonator to amplify laser light excited in a laser medium disposed between a pair of mirrors while the laser light reflects at said mirrors,
a half-wave plate to rotate the plane of polarization of the resonator output laser light,
a polarizer to transmit a first polarized light and to deflect a second polarized light receiving the laser light from said half-wave plate,
a beam splitter to deflect a portion of the first polarized light,
a photo detector to detect the intensity of the laser light deflected by said beam splitter,
a drive-control means to control the rotation of said half-wave plate according to the output of said photo detector to keep the intensity of the laser light out of the polarizer at the predetermined value,
a case to contain said laser medium, said pair of mirrors, said half-wave plate, said polarizer and said beam splitter, and
an exit window opened in the case to lead out the first polarized light.

3. The laser apparatus of claim 1, wherein an alarm means is installed to give alarm according to the output of said photo detector that the intensity of the first polarized laser light is near the intensity of the resonator output laser light.

4. The laser apparatus of claim 3, wherein said drive-control means includes a logic circuit to inform an alarm signal of said alarm means when the intensity of the resonator output laser light is decreased near the intensity of the first polarized laser light.

5. The laser apparatus of claim 1, wherein the predetermined value is from 0.3 to 0.95 of the maximum intensity of the resonator output laser light.

6. The laser apparatus of claim 1, wherein an adjusting means to adjust the plane of polarization without changing the beam shape or character of the first polarized light by rotating said polarizer according to the rotation of said half-wave plate is installed in said drive-control means.

7. The laser apparatus of claim 6, wherein the angular velocity of rotation of said polarizer is twice of the angular velocity of rotation of said half-wave plate.

8. A laser apparatus comprising:
a resonator to amplify laser light excited in a laser medium disposed between a pair of mirrors while the laser light reflects at said mirrors,
a half-wave plate to rotate the plane of polarization of the resonator output laser light,
a polarizer to transmit a first polarized light and to deflect a second polarized light receiving the laser light from said half-wave plate,
a photo detector to detect the intensity of the output laser light passed through said half-wave plate and said polarizer,
a drive-control means to control the rotation of said half-wave plate according to the output of said photo detector to keep the intensity of the output laser light at the predetermined value,
a maximum output display device to display the maximum output power of said resonator, and
a final output power display device to display the output laser light passed through said polarizer.

9. The laser apparatus of claim 8, comprising:
a first calculation circuit to calculate the output laser power receiving the rotation angle of said half-wave plate and the output signal of said photo detector and
a power-to-angle graph display means to display the graph indicating the output laser power with respect to the rotation angle of said half-wave plate based upon the result of the first calculation circuit.

10. The laser apparatus of claim 9, further comprising:
a second calculation circuit to calculate the resonator output Fᵢₙ with the equation
Fᵢₙ=Fₒᵤₜ(1/cos²(2θ))
receiving the signal of the rotation angle θ of the half-wave plate and the signal of the output laser power Fₒᵤₜ from the photo detector, and
a resonator-output display means to display the resonator output power.

11. The laser apparatus of claim 10, further comprising:
a comparator to compare the output laser power Fₒᵤₜ with the resonator output Fᵢₙ, and
an alarm display means to display that the resonator output Fᵢₙ reached at the predetermined ratio with respect to the output laser power Fₒᵤₜ according to the output of said comparator.

12. The laser apparatus of claim 2, wherein an alarm means is installed to give alarm according to the output of said photo detector that the intensity of the first polarized laser light is near the intensity of the resonator output laser light.

13. The laser apparatus of claim 12, wherein said drive-control means includes a logic circuit to inform an alarm signal of said alarm means when the intensity of the resonator output laser light is decreased near the intensity of the first polarized laser light.

14. The laser apparatus of claim 2, wherein the predetermined value is from 0.3 to 0.95 of the maximum intensity of the resonator output laser light.

15. The laser apparatus of claim 3, wherein the predetermined value is from 0.3 to 0.95 of the maximum intensity of the resonator output laser light.

16. The laser apparatus of claim 12, wherein the predetermined value is from 0.3 to 0.95 of the maximum intensity of the resonator output laser light.

17. The laser apparatus of claim 4, wherein the predetermined value is from 0.3 to 0.95 of the maximum intensity of the resonator output laser light.

18. The laser apparatus of claim 13, wherein the predetermined value is from 0.3 to 0.95 of the maximum intensity of the resonator output laser light.

19. The laser apparatus of claim 2, wherein an adjusting means to adjust the plane of polarization without changing the beam shape or character of the first polarized light by rotating said polarizer according to the rotation of said half-wave plate is installed in said drive-control means.

20. The laser apparatus of claim 3, wherein an adjusting means to adjust the plane of polarization without changing the beam shape or character of the first polarized light by rotating said polarizer according to the rotation of said half-wave plate is installed in said drive-control means.

21. The laser apparatus of claim 12, wherein an adjusting means to adjust the plane of polarization without changing the beam shape or character of the first polarized light by rotating said polarizer according to the rotation of said half-wave plate is installed in said drive-control means.

22. The laser apparatus of claim 4, wherein an adjusting means to adjust the plane of polarization without changing the beam shape or character of the first polarized light by rotating said polarizer according to the rotation of said half-wave plate is installed in said drive-control means.

23. The laser apparatus of claim 13, wherein an adjusting means to adjust the plane of polarization without changing the beam shape or character of the first polarized light by rotating said polarizer according to the rotation of said half-wave plate is installed in said drive-control means.

24. The laser apparatus of claim 5, wherein an adjusting means to adjust the plane of polarization without changing the beam shape or character of the first polarized light by rotating said polarizer according to the rotation of said half-wave plate is installed in said drive-control means.

25. The laser apparatus of claim 14, wherein an adjusting means to adjust the plane of polarization without changing the beam shape or character of the first polarized light by rotating said polarizer according to the rotation of said half-wave plate is installed in said drive-control means.

26. The laser apparatus of claim 15, wherein an adjusting means to adjust the plane of polarization without changing the beam shape or character of the first polarized light by rotating said polarizer according to the rotation of said half-wave plate is installed in said drive-control means.

27. The laser apparatus of claim 16, wherein an adjusting means to adjust the plane of polarization without changing the beam shape or character of the first polarized light by rotating said polarizer according to the rotation of said half-wave plate is installed in said drive-control means.

28. The laser apparatus of claim 17, wherein an adjusting means to adjust the plane of polarization without changing the beam shape or character of the first polarized light by rotating said polarizer according to the rotation of said half-wave plate is installed in said drive-control means.

29. The laser apparatus of claim 18, wherein an adjusting means to adjust the plane of polarization without changing the beam shape or character of the first polarized light by rotating said polarizer according to the rotation of said half-wave plate is installed in said drive-control means.
